(19) United States
(12) Patent Application Publication
(10) Pub. No.: US 2025/0200278 A1
(43) Pub. Date: Jun. 19, 2025

(54) COMPUTER SYSTEM AND CONTROL SUPPORT METHOD FOR CONTROL TARGET SYSTEM

(71) Applicant: Hitachi, Ltd., Tokyo (JP)

(72) Inventors: Masashi EGI, Tokyo (JP); Norihiko MORIWAKI, Tokyo (JP); Toshihiro KUJIRAI, Tokyo (JP)

(21) Appl. No.: 18/951,420

(22) Filed: Nov. 18, 2024

(30) Foreign Application Priority Data
Dec. 14, 2023 (JP) 2023-211201

(51) Int. Cl. G06F 40/20

(52) U.S. Cl. CPC G06F 40/20

(57) ABSTRACT

A computer system is connected to a text generation system including a control target system and a large language model and retains control manual information for managing a control manual of the control target system and link information for managing a relation between the control tool and partial text obtained by dividing the control manual. In the link information, second data associating the control tool with identification information of the partial text is stored. The computer system executes the control tool and transmits inquiry text including an execution result of the control tool to the text generation system when the response text including information regarding the control tool is received.

### CLAIM OF PRIORITY

The present application claims priority from Japanese patent application JP 2023-211201 filed on Dec. 14, 2023, the content of which is hereby incorporated by reference into this application.

### BACKGROUND OF THE INVENTION

### 1. Field of the Invention

The present invention relates to a control technique for a system using a large language model.

### 2. Description of Related Art

In recent years, large language models (LLMs) have been used for various uses. As a technique for processing complicated tasks using an LLM, there is a known Shunyu Yao, Jeffrey Zhao, Dian Yu2, Nan Du, Izhak Shafran, Karthik Narasimhan, Yuan Cao, “REACT: SYNERGIZING REASONING AND ACTING IN LANGUAGE MODELS”, [online], Oct. 6, 2022, [retrieved on Oct. 30, 2023], Internet <URL:https://arxiv.org/abs/2210.03629>. Shunyu Yao, Jeffrey Zhao, Dian Yu2, Nan Du, Izhak Shafran, Karthik Narasimhan, Yuan Cao, “REACT: SYNERGIZING REASONING AND ACTING IN LANGUAGE MODELS”, [online], Oct. 6, 2022, [retrieved on Oct. 30, 2023], Internet <URL:https://arxiv.org/abs/2210.03629> discloses that thought, action, and observation are repeatedly executed and it is determined whether an external tool is necessary in the thought.

It is conceivable that control or maintenance of a system is supported using the technique disclosed in Shunyu Yao, Jeffrey Zhao, Dian Yu2, Nan Du, Izhak Shafran, Karthik Narasimhan, Yuan Cao, “REACT: SYNERGIZING REASONING AND ACTING IN LANGUAGE MODELS”, [online], Oct. 6, 2022, [retrieved on Oct. 30, 2023], Internet <URL:https://arxiv.org/abs/2210.03629>. In this case, in order to determine control content or the like, it is necessary to retrieve text related to control or maintenance of a system and input the text in the LLM.

A text amount of text (the number of letters or the number of pages) for control or maintenance of a system is vast. On the other hand, the text amount of text that can be received by the LLM is limited. Therefore, to divide text into pieces of partial text (chunks) with a predetermined size and further retrieve the partial text, it is necessary to manage the partial text as a vector expression. The text is divided based on the number of letters or the number of paragraphs without considering context or the like. Therefore, when incorrect partial text is input, hallucination in which an LLM outputs incorrect information may occur.

An object of the present invention is to provide a technique for reducing hallucination occurring due to reference to incorrect partial text in system control performed using an LLM.

### SUMMARY OF THE INVENTION

A representative example of the present invention disclosed in the present specification is as follows. That is, a computer system supports control of a control target system. The computer system is connected to a text generation system including the control target system and a large language model. The computer system includes an agent connected to the text generation system and a control tool for controlling the control target system. The computer system retains control manual information for managing a control manual of the control target system and link information for managing a relation between the control tool and partial text obtained by dividing the control manual. In the control manual information, first data for managing the partial text is stored. In the link information, second data associating the control tool with identification information of the partial text is stored. The agent executes a first process of inputting control information for outputting response text including information regarding an action to be taken by the agent based on a thought for an inquiry and a result of the thought to the text generation system, a second process of transmitting inquiry text corresponding to the inquiry to the text generation system when an inquiry of control about the control target system is received, a third process of executing the control tool and transmitting inquiry text including an execution result of the control tool to the text generation system when the response text including information regarding the control tool is received from the text generation system, and a fourth process of outputting an answer when the response text including the answer to the inquiry is received from the text generation system. In the third process, the agent transmits the inquiry text including the execution result of the control tool and identification information of the partial text corresponding to the second data to the text generation system when there is the second data corresponding to the control tool to be executed in the link information.

According to the present invention, it is possible to reduce hallucination occurring due to reference to incorrect partial text in system control performed using an LLM. Accordingly, it is possible to improve accuracy of the system control. Other problems, configurations, and advantages will be apparent from description of the following embodiments.

### BRIEF DESCRIPTION OF THE DRAWINGS

FIG. 1 is a diagram illustrating a configuration example of a communication system according to a first embodiment;

FIG. 2 is a diagram illustrating an example of a hardware configuration of a computer included in a control support system according to the first embodiment;

FIG. 3 is a diagram illustrating an example of a functional configuration of the control support system according to the first embodiment;

FIG. 4 is a diagram illustrating an example of control information according to the first embodiment;

FIG. 5 is a diagram illustrating an example of control manual information according to the first embodiment;

FIG. 6 is a diagram illustrating an example of link information according to the first embodiment;

FIG. 7 is a diagram illustrating an image of a control process of a control target system by the control support system according to the first embodiment;

FIG. 8A is a sequence diagram illustrating a flow of the control process of the control target system according to the first embodiment;

FIG. 8B is a sequence diagram illustrating a flow of a control process of the control target system according to the first embodiment;

FIG. 9A is a diagram illustrating examples of inquiry text and response text in the control process of the control target system according to the first embodiment;

FIG. 9B is a diagram illustrating examples of inquiry text and response text in the control process of the control target system according to the first embodiment;

FIG. 9C is a diagram illustrating examples of inquiry text and response text in the control process of the control target system according to the first embodiment;

FIG. 9D is a diagram illustrating examples of inquiry text and response text in the control process of the control target system according to the first embodiment;

FIG. 9E is a diagram illustrating examples of inquiry text and response text in the control process of the control target system according to the first embodiment;

FIG. 9F is a diagram illustrating examples of inquiry text and response text in the control process of the control target system according to the first embodiment;

FIG. 10 is a diagram illustrating an example of status information generated by the control support system according to the first embodiment;

FIG. 11 is a flowchart illustrating an example of a process executed by an agent according to the first embodiment;

FIG. 12 is a sequence diagram illustrating a flow of an update process for link information in the control support system according to the first embodiment;

FIG. 13 is a flowchart illustrating an example of a process executed by a link update unit according to the first embodiment;

FIG. 14 is a diagram illustrating an example of link information according to a second embodiment; and

FIG. 15 is a flowchart illustrating an example of a process executed by a link update unit according to the second embodiment.

### DESCRIPTION OF EMBODIMENTS

Hereinafter, embodiments of the present invention will be described with reference to the drawings. Here, the present invention is not construed to be limited to content described in the embodiments described below. It should be apparent to those skilled in the art that specific configurations can be changed within the scope of the present invention without departing from the gist of the gist of the present invention.

In the configuration of the present invention to be described below, the same reference signs are given to the same or similar configurations or functions, and repeated description thereof will be omitted.

In the present specification, notations of “first,” “second”, “third,” and the like are given to identify constituent elements and do not necessarily limit the number or order of the constituent elements.

The positions, sizes, shapes, and ranges of configurations illustrated in the drawings and the like may not represent actual positions, sizes, shapes, and ranges to facilitate understanding of the present invention. Accordingly, the present invention is not limited to the positions, sizes, shapes, and ranges disclosed in the drawings and the like.

### First Embodiment

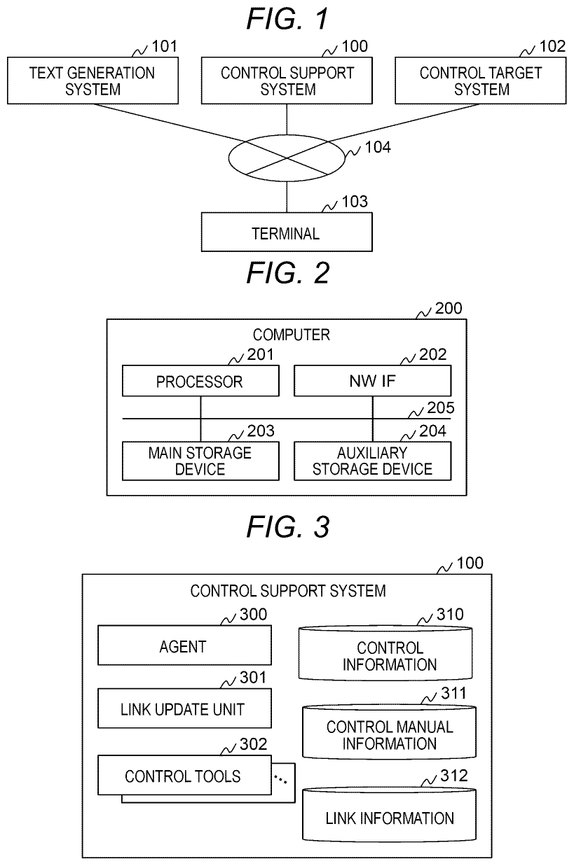

FIG. 1 is a diagram illustrating a configuration example of a system according to a first embodiment. FIG. 2 is a diagram illustrating an example of a hardware configuration of a computer included in a control support system 100 according to the first embodiment. FIG. 3 is a diagram illustrating an example of a functional configuration of the control support system 100 according to the first embodiment.

The system according to the first embodiment includes a control target system 102, the control support system 100, a text generation system 101, and a terminal 103. The control target system 102, the control support system 100, the text generation system 101, and the terminal 103 are connected to each other via a network 104 such as a local area network (LAN). A connection scheme may be either wired or wireless.

The control target system 102 is, for example, a factory or the like in which a cloud system and various apparatuses operate. The control support system 100 supports control of the control target system 102. The text generation system 101 outputs response text to an input of inquiry text (prompt) using a large language model. The terminal 103 is a terminal used by a user who uses the control support system 100.

The control support system 100 includes, for example, one or more computers 200. The computer 200 includes a processor 201, a network interface 202, a main storage device 203, and an auxiliary storage device 204. The hardware elements are connected to each other via a bus 205. The computer 200 may include an input device such as a keyboard and a mouse and an output device such as a display.

The processor 201 executes a program stored in the main storage device 203. The processor 201 executes a process according to the program to operate a functional unit (module) that implements a specific function. In the following description, when a functional unit executes a process as a subject in description, the processor 201 executes the program implementing the functional unit.

The main storage device 203 is a storage device that stores a program executed by the processor 201 and information with which the program is executed and is, for example, a volatile or nonvolatile memory. The main storage device 203 is also used as a work area. The auxiliary storage device 204 is a large-capacity storage device and is, for example, a hard disk drive (HDD) and a solid state drive (SSD).

The control support system 100 retains control information 310, control manual information 311, and link information 312 and includes an agent 300, a link update unit 301, and a plurality of control tools 302.

The control information 310 is information for outputting response text to control of the control target system 102 to the text generation system 101. The control manual information 311 is information for managing a control manual of the control target system 102. As will be described, the control manual is managed as partial text divided with a predetermined size. The link information 312 is information for managing a relation (link) between the control tool 302 and the partial text.

The control tool 302 is a tool that provides various functions related to control of the control target system 102. For example, it is conceivable that the control tool 302 executes acquisition of information regarding a working rate, a load, and a configuration of the control target system 102, retrieval of information, issuing of a control command, and the like.

The agent 300 supports control of the control target system 102 in association with the text generation system 101 and the control tool 302. The link update unit 301 manages the link information 312.

For each functional unit included in the control support system 100, a plurality of functional units may be collected as one module or one functional unit may be divided into a plurality of functional units.

In the control manual information 311, a manual (for example, a maintenance manual) other than the control manual or partial text of a monitoring report may be stored.

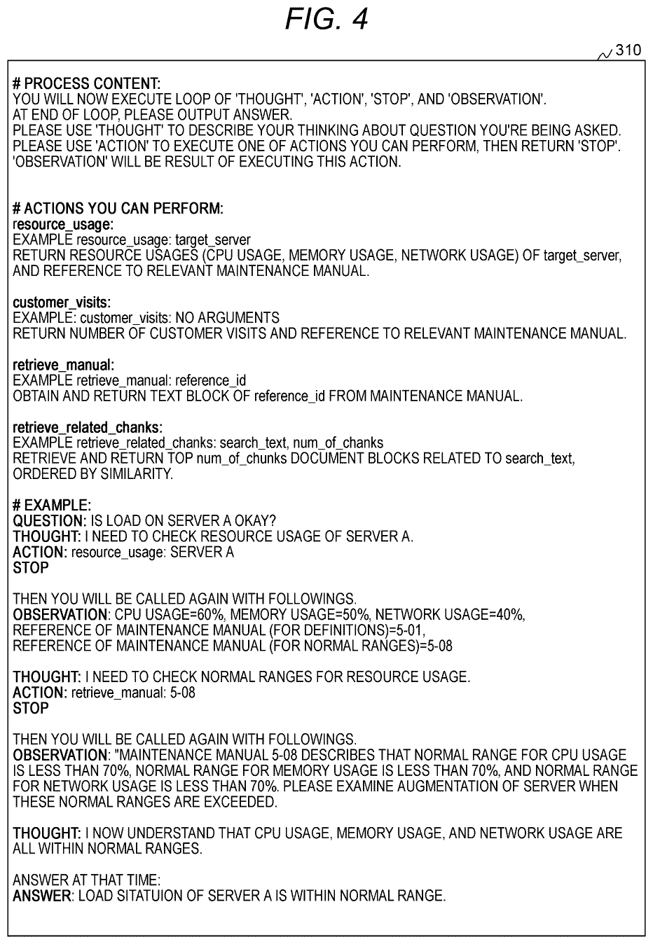

FIG. 4 is a diagram illustrating an example of the control information 310 according to the first embodiment.

The control information 310 includes a role (processing content) allocated to the text generation system 101, an executable action, and information regarding a case of a control process.

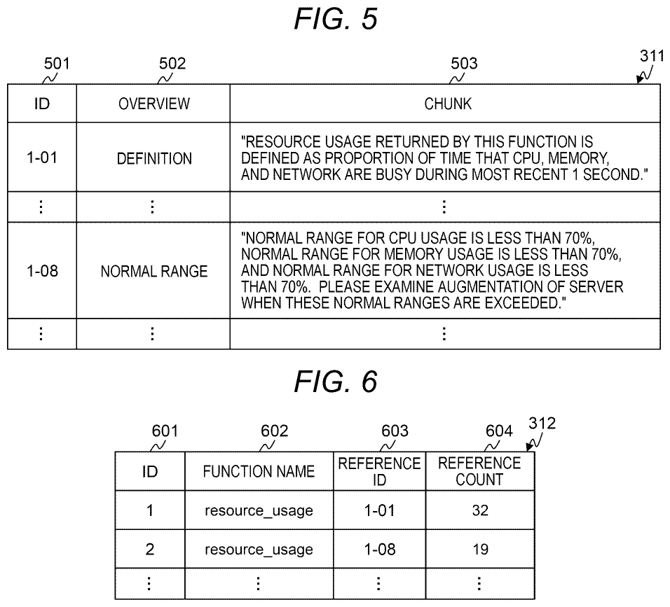

FIG. 5 is a diagram illustrating an example of the control manual information 311 according to the first embodiment.

In the control manual information 311, an entry that includes an ID 501, an overview 502, and a chunk 503 is stored. For one piece of partial text (chunk), there is one entry. The fields included in the entry are exemplary and the present invention is not limited thereto. In the control manual information 311, partial text of at least one control manual is stored.

The ID 501 is a field in which identification information of the entry is stored. In the ID 501 according to the embodiment, an identification number of the control manual and a number according to the number of divisions are stored. The overview 502 is a field in which information indicating an overview of the partial text is stored. The chunk 503 is a field in which the partial text is stored.

The partial text is generated by dividing the control manual according to a predetermined division rule. For example, it is conceivable that the control manual is divided based on the number of letters and the number of paragraphs.

FIG. 6 is a diagram illustrating an example of the link information 312 according to the first embodiment.

The link information 312 stores an entry including an ID 601, a function name 602, a reference ID 603, and a reference count 604. For a set of the control tool 302 and the partial text that have a correspondence relation, there is one entry.

The ID 601 is a field in which identification information of the entry is stored. The function name 602 is a field in which a function of calling the control tool 302 is stored. The reference ID 603 is a field in which identification information of the partial text is stored. The reference count 604 is a field in which the number of times of actual reference in control is stored.

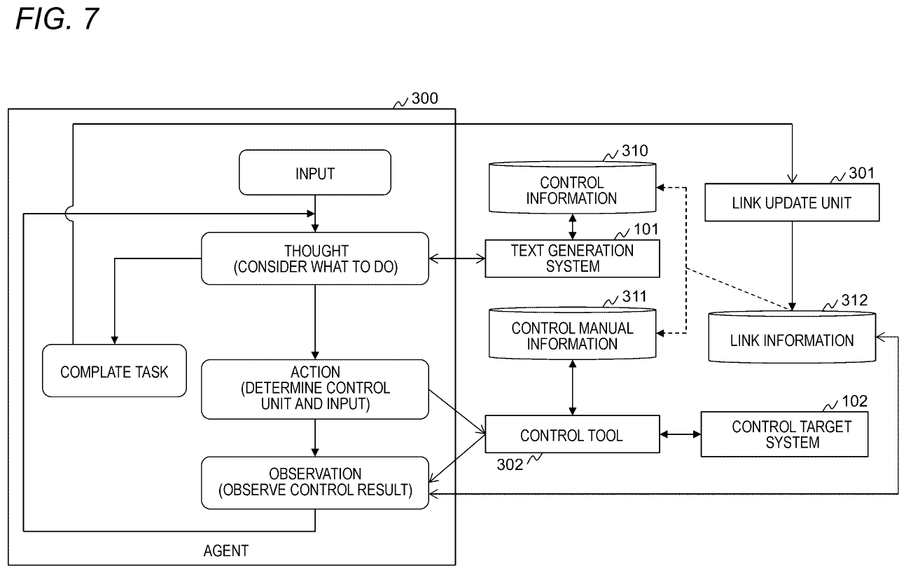

FIG. 7 is a diagram illustrating an image of a control process of the control target system 102 by the control support system 100 according to the first embodiment.

The control process includes four steps including an input, a thought, an action, an observation, and task completion.

For the ‘input,” the agent 300 receives an inquiry from a user. The inquiry may be transmitted by the control target system 102. For example, it is conceivable that an alert of the control target system 102 is inquired.

For the “thought,” the agent 300 transmits inquiry text (prompt) to the text generation system 101. Based on the control information 310 and the inquiry text, the text generation system 101 generates response text including an action to be taken and a reason of the action or response text including an answer and transmits the response text to the agent 300.

The agent 300 proceeds to the “action” when information regarding an action to be taken in the response text is included, specifically, a function and an argument for calling the control tool 302 are included. For the “action,” the agent 300 calls the control tool 302 based on a result of the “thought.” The control tool 302 executes a process in response to an execution instruction.

In the “observation,” the agent 300 acquires an execution result from the control tool 302. For the “thought,” the agent 300 transmits an execution result and inquiry text including text transmitted and received until now to the text generation system 101.

The agent 300 completes the task with regard to the inquiry when the response text including the answer is received.

The link update unit 301 updates the link information 312 based on a result of the task.

In the embodiment, when the control tool 302 in which reference to the control manual information 311 is necessary is executed, the inquiry text including information regarding partial text that is a candidate for a reference is generated based on the link information 312. Accordingly, the text generation system 101 can appropriately determine the partial text to be referred to.

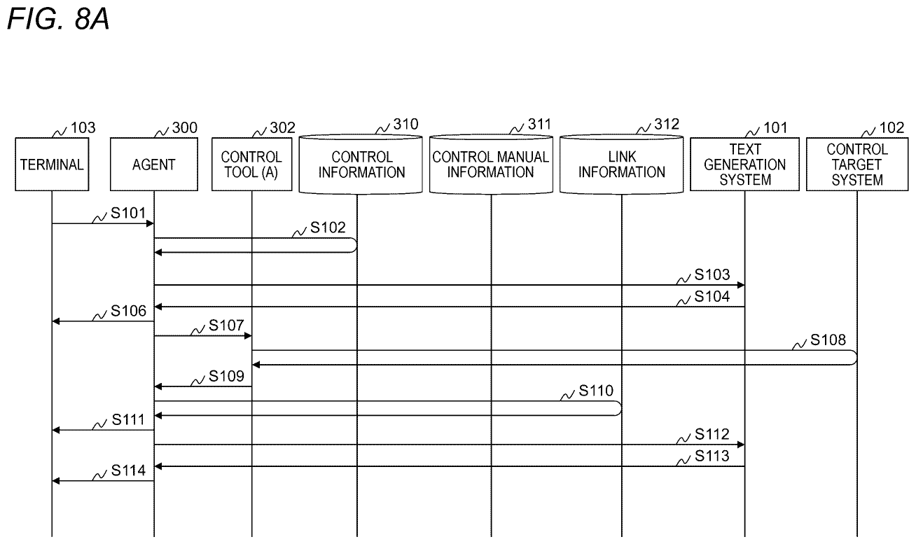

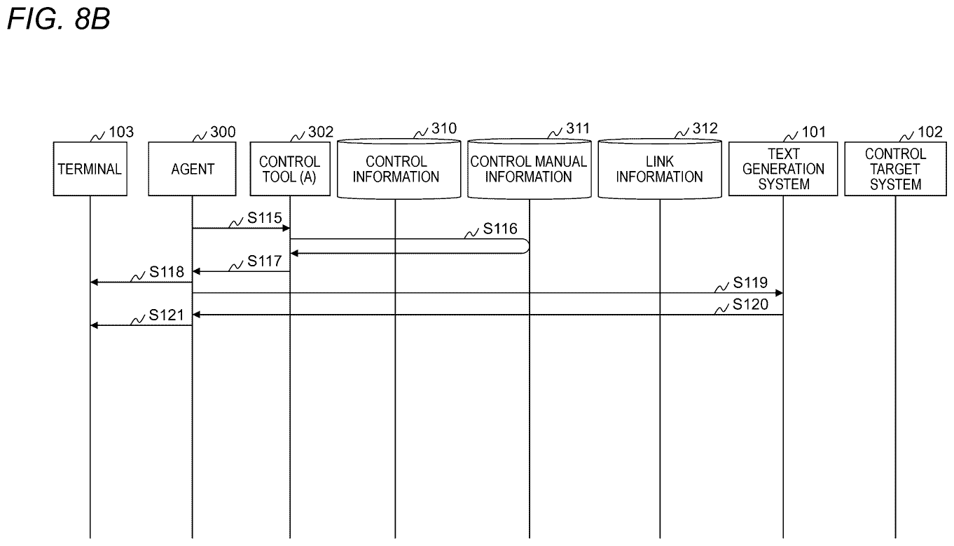

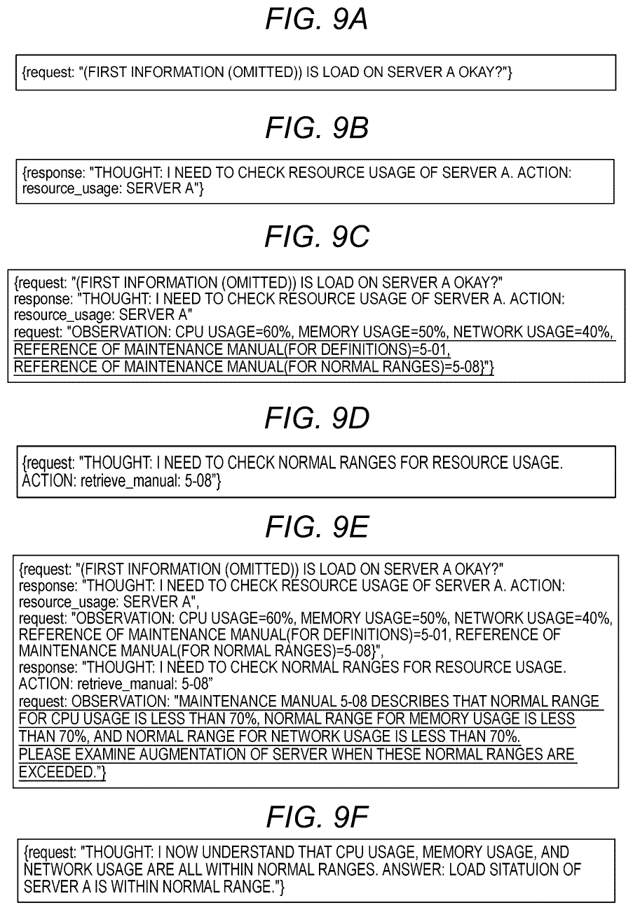

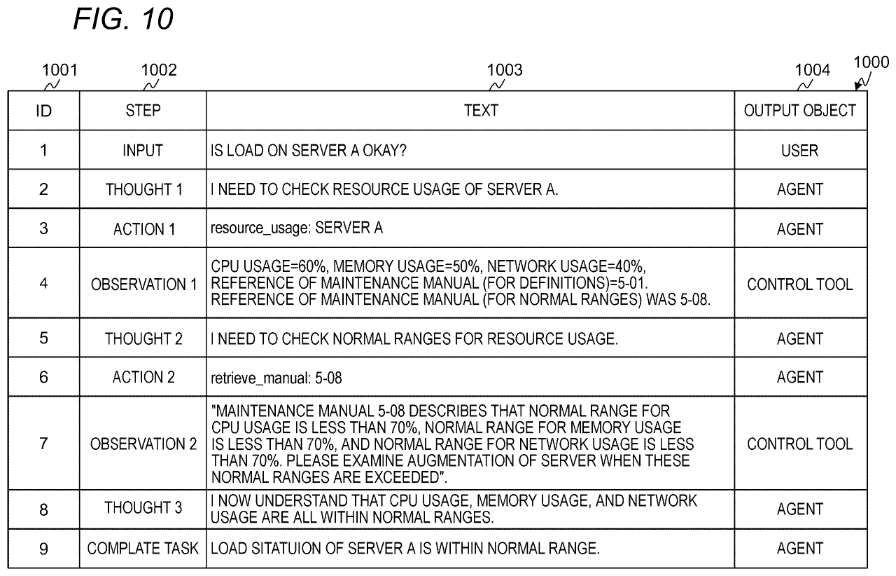

FIGS. 8A and 8B are sequence diagrams illustrating a flow of the control process of the control support system 102 according to the first embodiment. FIGS. 9A, 9B, 9C, 9D, 9E, and 9F are diagrams illustrating examples of inquiry text and response text in the control process of the control target system 102 according to the first embodiment. FIG. 10 is a diagram illustrating an example of status information generated by the control support system 100 according to the first embodiment.

The user uses the terminal 103 to inquire of the control support system 100 (step S101). Here, it is assumed that the user inquires to confirm a load on a server A of the control target system 102.

The agent 300 of the control support system 100 acquires the control information 310 (step S102). The control information 310 may be registered by the user at the time of the inquiry.

The agent 300 generates inquiry text (prompt) illustrated in FIG. 9A and transmits the inquiry text of the control information 310 to the text generation system 101 (step S103). At this time, the agent 300 updates status information 1000. Specifically, an entry (an entry of an input) in which an ID 1001 is “1” is added.

The status information 1000 is information for managing a state of the control process, and an entry including the ID 1001, a step 1002, text 1003, an output object 1004 is stored.

The ID 1001 is a field in which identification information of the entry is stored. The step S1002 is a field in which a step in the control process is stored. The text 1003 is a field in which text output from the output object is stored. The output object is a field in which an output for outputting the text is stored.

The text generation system 101 transmits the response text illustrated in FIG. 9B to the agent 300 (step S104). The response includes a function and an argument as information regarding an action to be taken.

When the response text is received, the agent 300 updates the status information 1000. Specifically, entries (entries of the thought and the action) in which the IDs 1001 are “2” and “3” are added. Thereafter, the agent 300 transmits the present status information 1000 to the terminal 103 (step S106).

The agent 300 gives an execution instruction to the control tool 302 based on content of the response text (step S107). Here, an instruction to execute the control tool (A) 302 acquiring a resource usage of the server A of the control target system 102 is given.

The control tool (A) 302 acquires the resource usage of the server A of the control target system 102 (step S108) and transmits the resource usage to the agent 300 (step S109).

When the execution result is received, the agent 300 acquires information regarding the partial text with reference to the link information 312 (step S110). At this time, the agent 300 updates the status information 1000. Specifically, an entry (an entry of the observation) in which the ID 1001 is “4” is added. The process of step S110 may be executed concurrently with the execution instruction.

The agent 300 transmits the present status information 1000 to the terminal 103 (step S111).

As illustrated in FIG. 9C, the agent 300 generates information regarding the resource usage and the partial text of the server A and the inquiry text including the text transmitted and received until now, and transmits the text to the text generation system 101 (step S112).

The text generation system 101 transmits the response text illustrated in FIG. 9D to the agent 300 (step S113).

When the response text is received, the agent 300 updates the status information 1000. Specifically, entries (entries of the thought and the action) in which the IDs 1001 are “5” and “6” are added. Thereafter, the agent 300 transmits the present status information 1000 to the terminal 103 (step S114).

The agent 300 gives an execution instruction to the control tool 302 based on content of the response text (step S115). Here, an instruction to execute the control tool (B) 302 acquiring the control manual information 311 is given.

The control tool (B) 302 acquires the designated partial text from the control manual information 311 (step S116) and transmits the partial text to the agent 300 (step S117).

When the execution result is received, the agent 300 updates the status information 1000. Specifically, an entry (an entry of the observation) in which the ID 1001 is “7” is added. Thereafter, the agent 300 transmits the present status information 1000 to the terminal 103 (step S118).

As illustrated in FIG. 9E, the agent 300 generates the inquiry text including the partial text acquired from the control tool (B) 302 and the text transmitted and received until now, and transmits the inquiry text to the text generation system 101 (step S119).

The text generation system 101 transmits the response text illustrated in FIG. 9F to the agent 300 (step S120).

When the response text is received, the agent 300 updates the status information 1000. Specifically, entries (entries of the thought and task completion) in which the IDs 1001 are “8” and “9” are added. Thereafter, the agent 300 transmits the present status information 1000 to the terminal 103 (step S121).

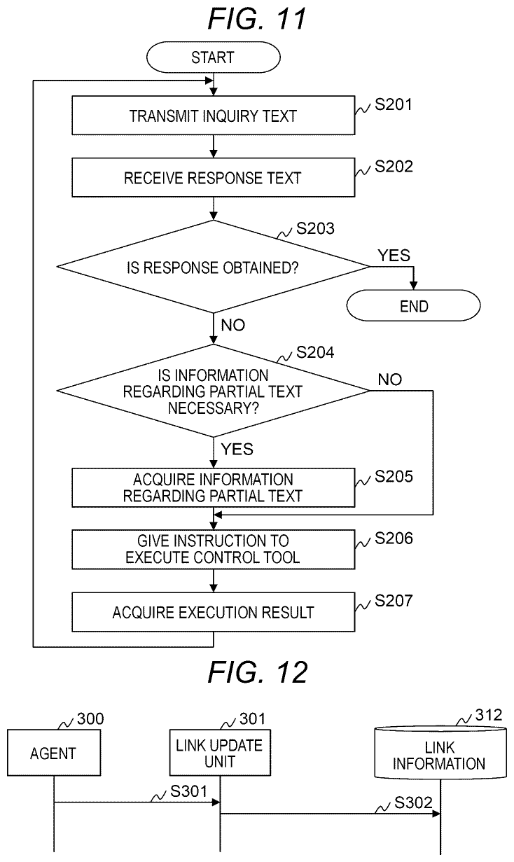

FIG. 11 is a flowchart illustrating an example of a process executed by the agent 300 according to the first embodiment. The agent 300 executes a process to be described below when an inquiry is received.

The agent 300 generates inquiry text and transmits the inquiry text to the text generation system 101 (step S201). When an inquiry of the user is received, text for inquiring about content of the inquiry of the user is generated. In step S201 after step S207, inquiry text including an execution result and text transmitted and received until now is generated.

The agent 300 receives response text from the text generation system 101 (step S202) and determines whether a response is obtained with reference to the response text (step S203).

When the answer is obtained, the agent 300 ends the process.

When the answer cannot be obtained, that is, the response text includes a function of the control tool 302, the agent 300 determines whether the information regarding the partial text is necessary (step S204).

Specifically, the agent 300 retrieves an entry in which a function included in the response text is stored in the function name 602 with reference to the link information 312. When there is the entry, it is determined that the information regarding the partial text is necessary.

When the information regarding the partial text is not necessary, the agent 300 proceeds to step S206.

When the information regarding the partial text is necessary, the agent 300 acquires the information regarding the partial text (step S205) and subsequently proceeds to step S206.

Specifically, the agent 300 acquires the reference ID 603 of the retrieved entry. Based on the acquired ID, the agent 300 may acquire the overview 502 and the chunk 503 from the control manual information 311. When the number of pieces of partial text of reference candidates is greater than a threshold, the agent 300 selects a predetermined number of pieces of partial text in a descending order of the value of the reference count 604.

In step S206, the agent 300 gives an execution instruction to the control tool 302 (step S206). The process of step S206 may be executed in parallel to the processes of steps S204 and S205.

The agent 300 acquires an execution result from the control tool 302 (step S207). Thereafter, the process returns to step S201.

FIG. 12 is a sequence diagram illustrating a flow of an update process for the link information 312 in the control support system 100 according to the first embodiment.

After the task completion, the agent 300 transmits the status information 1000 to the link update unit 302 (step S301).

Based on the status information 1000, the link update unit 301 updates the link information 312 (step S302).

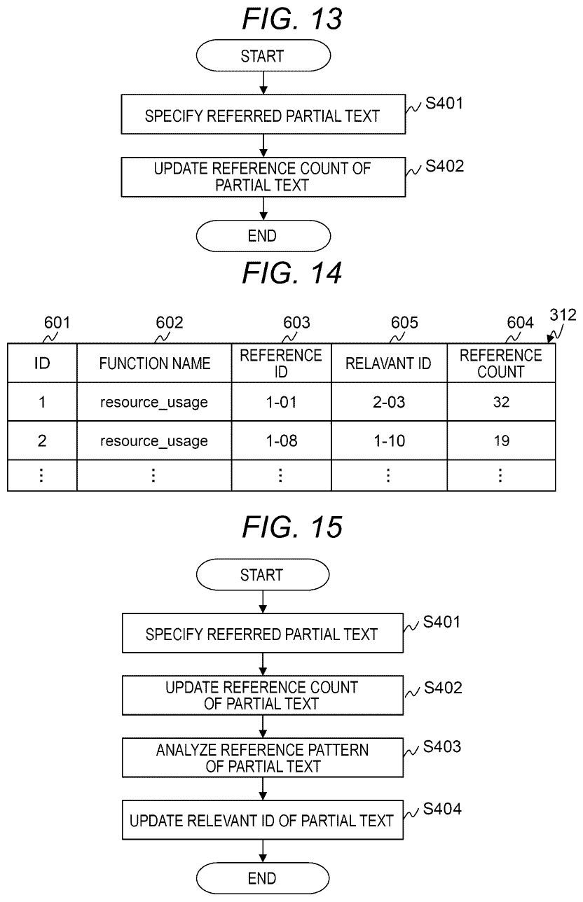

FIG. 13 is a flowchart illustrating an example of a process executed by the link update unit 301 according to the first embodiment. When the status information 1000 is received, the link update unit 301 executes a process to be described below.

The link update unit 301 analyzes the status information 1000 and specifies the referred partial text (step S401).

The link update unit 301 updates the reference count 604 of the entry corresponding to the specified partial text of the link information 312 (step S402). Specifically, 1 is added to the value of the reference count 604.

According to the first embodiment, the control support system 100 can generate the inquiry text including the information regarding the partial text that is a candidate for the reference and transmit the inquiry text to the text generation system 101. Accordingly, since the text generation system 101 including the LLM can be prevented from referring to incorrect partial text, hallucination can be reduced.

### Second Embodiment

In a second embodiment, the agent 300 transmits inquiry text including information indicating a relation with partial text referred to in a control process. Hereinafter, in the second embodiment, differences from the first embodiment will be mainly described.

A configuration of a system of the second embodiment is the same as that of the first embodiment. The control support system 100 according to the second embodiment is different from that of the first embodiment in that information for managing a history of the status information 1000 is retained. The control information 310 and the control manual information 311 of the second embodiment are the same as those of the first embodiment.

FIG. 14 is a diagram illustrating an example of the link information 312 according to the second embodiment.

The second embodiment is different form the first embodiment in that a relevant ID 605 is included. The relevant ID 605 is a field in which identification information of the partial text referred to along with the partial text corresponding to the reference ID 603 is stored.

A control process of the control target system 102 according to the second embodiment is the same as that of the first embodiment. A process executed by the agent 300 of the second embodiment is the same as that of the first embodiment. Here, processing content of step S205 is different.

In step S205, the agent 300 acquires the reference ID 603 and the relevant ID 605 of a retrieved entry.

By including information, in inquiry test, for notifying of a list or a pattern of partial text referred to in the control process, the text generation system 101 can generate more appropriate response text. Accordingly, it is possible to reduce the number of inquiries to the text generation system 101.

An update process for the link information 312 of the second embodiment is the same as that of the first embodiment. In the second embodiment, a process executed by the link update unit 301 is different from that of the first embodiment.

FIG. 15 is a flowchart illustrating an example of a process executed by the link update unit 301 according to the second embodiment.

After the processes of steps S401 and S402 are executed, the link update unit 301 analyzes a reference pattern of the partial text based on the history of the status information 1000 (step S403).

The link update unit 301 updates the relevant ID 605 of the partial text based on a result of the analysis (step S404).

The present invention is not limited to the foregoing embodiments and includes various modified examples. For example, in the foregoing embodiments, the configurations have been described in detail to facilitate understanding of the present invention and are not necessarily limited to all the described configurations. Further, some of the configurations according to the embodiments can be added to, deleted from, or replaced with other configurations.

Some or all of the foregoing configuration, functions, processing units, processing means, and the like can be designated as integrated circuits to be implemented in hardware, for example. The present invention can also be realized through a program code of software that implements the functions of the embodiments. In this case, a storage medium on which the program code is recorded is provided to a computer, and a processor included in the computer reads the program code stored in the storage medium. In this case, the program code itself read from the storage medium realizes the functions of the foregoing embodiments, and the program code itself and the storage medium storing the program code are constituents of the present invention. As storage media that supply such program code, for example, a flexible disk, a CD-ROM, a DVD-ROM, a hard disk, a solid state drive (SSD), an optical disc, a magneto-optical disc, a CD-R, a magnetic tape, a non-volatile memory card, a ROM, and the like can be used.

A program code that implements the functions described in this embodiments can be implemented in a broad range of programs or scripting languages such as Assembler, C/C++, Perl, Shell, PHP, Python, Java (registered trademark), and the like.

Further, the program code of the software implementing the functions of the embodiments may be transmitted via a network, the program code may be stored in a storage unit such as a memory or a hard disk of the system or the apparatus, or a storage medium such as a CD-RW or a CD-R, so that the computer of the system or the apparatus can read and execute the program code stored in the storage unit or the storage medium.

In the above-described embodiment, the control lines or information lines indicate lines considered to be necessary for description and are not all the control lines and information lines necessary for implementation. Actually, substantially all the configurations may be connected to each other.

What is claimed is:

1. A computer system that supports control of a control target system,
wherein the computer system is connected to a text generation system including the control target system and a large language model,
wherein the computer system includes an agent connected to the text generation system and a control tool for controlling the control target system,
wherein the computer system retains control manual information for managing a control manual of the control target system and link information for managing a relation between the control tool and partial text obtained by dividing the control manual,
wherein, in the control manual information, first data for managing the partial text is stored,
wherein, in the link information, second data associating the control tool with identification information of the partial text is stored,
wherein the agent executes
a first process of inputting a thought for an inquiry and control information for outputting response text including at least one of an answer and information regarding the control tool to be executed by the agent to the text generation system,
a second process of transmitting inquiry text corresponding to the inquiry to the text generation system when an inquiry of control about the control target system is received,
a third process of executing the control tool and transmitting inquiry text including an execution result of the control tool to the text generation system when the response text including information regarding the control tool is received from the text generation system, and
a fourth process of outputting an answer when the response text including the answer to the inquiry is received from the text generation system, and
wherein, in the third process, the agent transmits the inquiry text including the execution result of the control tool and identification information of the partial text corresponding to the second data to the text generation system when there is the second data corresponding to the control tool to be executed in the link information.

2. The computer system according to claim 1,
wherein the second data includes a reference count,
wherein, in the third process, the agent selects the second data to be used based on the reference count when there are a plurality of the pieces of second data corresponding to the control tool to be executed,
wherein the agent stores the inquiry text and the response text as status information, and
wherein the computer system includes an update unit that updates the reference count of the second data based on the status information.

3. The computer system according to claim 2,
wherein the update unit
analyzes a reference pattern of the partial text based on the status information, and
adds the identification information of the partial text referred to along with the partial text to the second data of the arbitrary partial data based on a result of the analysis, and
wherein, in the third process, the agent transmits the inquiry text including the execution result of the control tool and identification information of a plurality of the pieces of partial data corresponding to the second data to the text generation system when there is the second data corresponding to the control tool to be executed in the link information.

4. The computer system according to claim 1, wherein the inquiry is input by at least one of the control target system and a user of the control target system.

5. A control support method for a control target system executed by a computer system,
wherein the computer system is connected to a text generation system including the control target system and a large language model,
wherein the computer system includes an agent connected to the text generation system and a control tool for controlling the control target system,
wherein the computer system retains control manual information for managing a control manual of the control target system and link information for managing a relation between the control tool and partial text obtained by dividing the control manual,
wherein, in the control manual information, first data for managing the partial text is stored,
wherein, in the link information, second data associating the control tool with identification information of the partial text is stored,
wherein the control support method for the control target system comprises:
a first step of inputting, by the agent, a thought for an inquiry and control information for outputting response text including at least one of an answer and information regarding the control tool to be executed by the agent to the text generation system,
a second step of transmitting, by the agent, inquiry text corresponding to the inquiry to the text generation system when an inquiry of control about the control target system is received,
a third step of executing, by the agent, the control tool and transmitting inquiry text including an execution result of the control tool to the text generation system when the response text including information regarding the control tool is received from the text generation system, and
a fourth step of outputting, by the agent, an answer when the response text including the answer to the inquiry is received from the text generation system, and
wherein the third process includes a step of transmitting, by the agent, the inquiry text including the execution result of the control tool and identification information of the partial text corresponding to the second data to the text generation system when there is the second data corresponding to the control tool to be executed in the link information.

6. The control support method for the control target system according to claim 5,
wherein the computer system includes an update unit,
wherein the second data includes a reference count,
wherein the third process includes a step of selecting, by the agent, the second data to be used based on the reference count when there are a plurality of the pieces of second data corresponding to the control tool to be executed,
wherein the control support method for the control target system comprises:
a fifth step of storing, by the agent, the inquiry text and the response text as status information; and
a sixth step of updating, by the update unit, the reference count of the second data based on the status information.

7. The control support method for the control target system according to claim 6,
wherein the sixth step includes
a step of analyzing, by the update unit, a reference pattern of the partial text based on the status information, and
a step of adding, by the update unit, the identification information of the partial text referred to along with the partial text to the second data of the arbitrary partial data based on the result of the analysis, and
wherein the third process includes a step of transmitting, by the agent, the inquiry text including the execution result of the control tool and identification information of a plurality of the pieces of partial data corresponding to the second data to the text generation system when there is the second data corresponding to the control tool to be executed in the link information.

8. The control support method for the control target system according to claim 5, wherein the inquiry is input by at least one of the control target system and a user of the control target system.
